(19) United States
(12) Patent Application Publication
(10) Pub. No.: US 2026/0267480 A1
(43) Pub. Date: Sep. 10, 2026

(54) METHOD, APPARATUS, DEVICE AND MEDIUM FOR VIDEO PROCESSING

(71) Applicant: Beijing Zitiao Network Technology Co., Ltd., Haidian District, Beijing (CN)

(72) Inventors: Anping Cao, Beijing (CN); Ben Xu, Beijing (CN); Nan Zhang, Beijing (CN); Liwu Li, Beijing (CN); Di Wu, Beijing (CN)

(21) Appl. No.: 19/157,668

(22) PCT Filed: Feb. 7, 2024
(86) PCT No.: PCT/CN2024/076718

§ 371 Date: Aug. 18, 2025

(30) Foreign Application Priority Data
Feb. 17, 2023 (CN) 202310146762.1

(51) Int. Cl. G06F 3/0484

(52) U.S. Cl. CPC G06F 3/0484; G06F 2203/04806

(57) ABSTRACT

The embodiments of the disclosure relate to a method, an apparatus, a device, and a medium for video processing. In the method, a first triggering operation for a first video frame of a video is received. In response to the first triggering operation, associated information of the first video is displayed. In the embodiments of the disclosure, by recommending associated information based on the video, the acquisition needs for the associated information of the first video in different scenarios may be flexibly met, the accuracy of acquiring the associated information of the video frame is improved, and the acquisition path of the associated information is shortened.

### CROSS-REFERENCE TO RELATED APPLICATION(S)

This application claims the benefit of Chinese Patent Application No. 202310146762.1, entitled “METHOD, APPARATUS, DEVICE AND MEDIUM FOR VIDEO PROCESSING” filed on Feb. 17, 2023, the entire content of which is incorporated herein by reference.

### FIELD

The present disclosure relates to the field of computer application technologies, and in particular, to a method, an apparatus, a device, and a medium for video processing.

### BACKGROUND

With the development of computer application technologies, information propagation in the form of videos has become a relatively common way, in which, when watching corresponding videos on a client, the client may have different needs to understand the related video objects in the videos, for example, have a need to further understand the details of product objects in the videos.

In the related art, when there is a need to further understand video objects while playing a video on the client, the client needs to actively call the screenshot tool for screenshots, and the association information is obtained through screenshot in the search platform, so that the acquisition path for the video object is relatively long.

### SUMMARY

In order to solve the above technical problems or at least partially solve the above technical problems, the present disclosure provides a method, an apparatus, a device, and a medium for video processing.

The embodiments of the present disclosure provide a method for video processing, including: receiving a first triggering operation for a first video frame of a first video; in response to the first triggering operation, displaying associated information of the first video.

The embodiments of the present disclosure further provide an apparatus for video processing, including: a receiving module, configured to receive a first triggering operation for a first video frame of a video; a display processing module, configured to in response to the first triggering operation, display associated information of the first video.

The embodiments of the present disclosure further provide an electronic device, including: a processor; a memory configured to store executable instructions of the processor; the processor is configured to read the executable instructions from the memory and execute the executable instructions to implement the method for video processing provided in the embodiments of the present disclosure.

The embodiments of the present disclosure further provide a computer-readable storage medium storing a computer program, the computer program configured to execute the method for video processing provided in the embodiments of the present disclosure.

The embodiments of the present disclosure further provide a computer program product, when instructions in the computer program product are executed by a processor, the method for video processing described in the foregoing embodiments is implemented.

Compared with the prior art, the technical solutions provided in the embodiments of the present disclosure have the following advantages:

In the video processing scheme provided by the embodiments of the present disclosure, a first triggering operation for the first video frame of a video is received, and then, in response to the first triggering operation, the associated information of the first video is displayed. In the embodiments of the present disclosure, by recommending associated information based on the video, the acquisition needs for the associated information of the first video frame in different scenarios may be flexibly met, the accuracy of acquiring the associated information of the video frame is improved, and the acquisition path of the associated information is shortened.

### BRIEF DESCRIPTION OF DRAWINGS

With reference to the accompanying drawings and the following specific implementations, the above and other features, advantages, and aspects of the embodiments of the present disclosure will become more apparent. Throughout the drawings, the same or similar reference numbers refer to the same or similar elements. It should be understood that the drawings are schematic, and components and elements are not necessarily drawn to scale.

FIG. 1 is a schematic flowchart of a method for video processing according to the embodiments of the present disclosure;

FIG. 2 is a schematic diagram of a video processing scenario according to the embodiments of the present disclosure;

FIG. 3 is a schematic diagram of another video processing scenario according to the embodiments of the present disclosure;

FIG. 4 is a schematic diagram of another video processing scenario according to the embodiments of the present disclosure;

FIG. 5 is a schematic diagram of another video processing scenario according to the embodiments of the present disclosure;

FIG. 6 is a schematic diagram of another video processing scenario according to the embodiments of the present disclosure;

FIG. 7 is a schematic diagram of another video processing scenario according to an embodiment of the present disclosure;

FIG. 8 is a schematic diagram of another video processing scenario according to the embodiments of the present disclosure;

FIG. 9 is a schematic diagram of another video processing scenario according to the embodiments of the present disclosure;

FIG. 10 is a schematic diagram of another video processing scenario according to the embodiments of the present disclosure;

FIG. 11 is a schematic structural diagram of an apparatus for video processing according to embodiments of the present disclosure;

FIG. 12 is a schematic structural diagram of an electronic device provided in the embodiments of the present disclosure.

### DETAILED DESCRIPTION

The embodiments of the present disclosure will be described in more detail below with reference to the accompanying drawings. Although certain embodiments of the present disclosure are shown in the drawings, it should be understood that the present disclosure may be implemented in various forms, and should not be construed as limited to the embodiments set forth herein, and on the contrary, these embodiments are provided for a more thorough and complete understanding of the present disclosure. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and variations thereof are open-ended, i.e., “including but not limited to”. The term “based on” means “based at least in part on”. The term “one embodiment” means “at least one embodiment”; the term “another embodiment” means “at least one further embodiment”; the term “some embodiments” means “at least some embodiments”. The relevant definitions of other terms will be given in the following description.

It should be noted that the concepts such as “first” and “second” mentioned in the present disclosure are only used to distinguish different apparatuses, modules, or units, and are not intended to limit the order of functions performed by the apparatuses, modules, or units or their independent relationships.

It should be noted that the modification of “a” and “a plurality” mentioned in the present disclosure is illustrative and not limiting, and those skilled in the art should understand that, unless otherwise clearly indicated in the context, it should be understood as “one or more”.

The names of messages or information exchanged between multiple devices in implementations of the present disclosure are for illustrative purposes only and are not intended to limit the scope of such messages or information.

In order to solve the above problem, the embodiments of the present disclosure provide a method for video processing. In the method, based on the first video frame included in the first video, associated information is recommended, which may flexibly meet the acquisition needs for the associated information of the first video in different scenarios. The associated information of the corresponding first object is directly displayed, and there is no need to actively search based on screenshots in the search platform, greatly shortening the acquisition path of the associated information.

The method is described below with reference to specific embodiments.

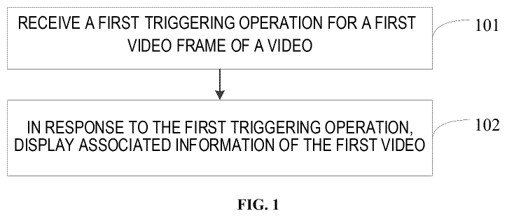

FIG. 1 is a schematic flowchart of a method for video processing provided in the embodiments of the present disclosure. This method may be executed by an apparatus for video processing, which may be implemented by using software and/or hardware and is generally integrated into electronic devices such as clients. As shown in FIG. 1, the method includes:

Step 101: Receive a first triggering operation for a first video frame of a video.

The first triggering operation may be any operation triggered by a pre-defined identifier. For example, it may be a press operation on the first video frame, or it may be an operation to call a predetermined triggering page on the first video frame.

Step 102: In response to the first triggering operation, display associated information of the first video.

In an embodiment of the present disclosure, in response to the first triggering operation, the associated information of the first video is directly displayed. Thus, the client may quickly obtain the corresponding associated information without taking screenshots and searching, which may flexibly meet the needs for obtaining the associated information of the first video in different scenarios and shorten the acquisition path of the associated information.

In an embodiment of the present disclosure, the associated information of the first video may be associated with the first object in the first video, wherein the first object in the first video frame is determined according to the first triggering operation on the first video. It should be emphasized that the first object in this embodiment corresponds to the trigger instruction. For example, the trigger area where the client executes the first triggering operation (such as the press operation mentioned above) may be obtained, and the video object corresponding to the trigger area in the first video frame is identified as the first object. Alternatively, at least one candidate video object within the operation area corresponding to the first triggering operation may be determined as the first object. The trigger weight of each candidate video object is obtained, which may be recognized according to a pre-trained convolutional model, etc. The candidate video object with a trigger weight greater than the predetermined weight threshold is determined as the first object. Thus, in this embodiment, the first object for which the client wants to obtain associated information may be accurately determined, which helps to ensure the accuracy of the subsequently obtained associated information.

In addition, in this embodiment, the triggering process may be implemented by existing object recognition algorithms. For example, the first video frame is up-sampled by using fully convolutional networks (FCN), and convolutional calculations are performed on the up-sampled image to obtain the first object. For example, the segmentation of video objects may be achieved through deep learning algorithms to obtain the corresponding first object.

In addition, in an embodiment of the present disclosure, the above associated information is determined according to the video type of the first video. It is also to be understood that the determination method of the associated information varies for different video types.

The following describes how to obtain the associated information of the first video and control the client to display the corresponding associated information with reference to specific embodiments.

In an embodiment of the present disclosure, displaying the associated information of the first video includes: displaying a plurality of multimedia content of different types related to the first video. The plurality of multimedia content of different types related to the first video may be the plurality of multimedia content of different types related to the first object in the first video. The multimedia content may be information about the first object (for example, if the first object is okra, the plurality of multimedia content of different types related to the first object may include text introductions of okra, okra display videos, or pictures). The different types include video type, text type, and picture type.

In this embodiment, if the multimedia content of the first video is taken as the associated information, the relevant server may obtain the object feature information of the first object. The specific content included in the object feature information is related to the specific application scenario. The server may determine, in the predetermined information resource library, information with a matching degree greater than the predetermined matching degree threshold as multimedia content.

In some possible embodiments, candidate search results matching the object feature information may be received, and a predetermined number of information items may be randomly screened from the candidate search results as multimedia content. When the candidate search results include predetermined popularity information, a predetermined number of information items may also be determined as multimedia content in the order of popularity from high to low.

Furthermore, in the embodiments of the present disclosure, the general purpose of obtaining multimedia content is to introduce the first object in multiple dimensions. Therefore, when controlling the client to display the associated information of the first object, an information push card area corresponding to the multimedia content may also be generated according to a predetermined template display style. The size and shape of the push card area are determined according to the predetermined display template style. Different multimedia contents correspond to different information push card areas, and a display page is generated according to the information push card areas. For example, a page is generated by combining multiple information push card areas, and the corresponding client is controlled to display this page, so as to comprehensively understand the specific first object at the client.

The first object may be an item in the first video, and the second object may be an item obtained after the item undergoes target effect processing.

In an embodiment, in response to the first triggering operation, displaying the associated information of the first video includes: in response to the first triggering operation, determining a first object associated with the first video; in response to a selection for a target effect, displaying a second object, the second object being generated based on the first object and the target effect.

In an embodiment, receiving the first triggering operation for the first video frame of the first video includes: receiving a press operation for the first video frame of the first video; in response to the first triggering operation, obtaining a first object associated with the first video includes: in response to the press operation, displaying the first object associated with the first video; in response to the selection for the target effect, displaying the second object includes: displaying at least one effect, in response to an operation of moving the first object onto the target effect of the at least one effect, displaying the second object.

In one embodiment, in response to a selection for a target effect, displaying the second object specifically means displaying an image of the second object. Determining the first object associated with the first video means determining an image of the first object associated with the first video. Besides, an image of the first object may also be displayed. Displaying the first object associated with the first video means displaying an image of the first object associated with the first video, and the operation of moving the first object to the target effect of the at least one effect means moving an image of the first object to the target effect of the at least one effect.

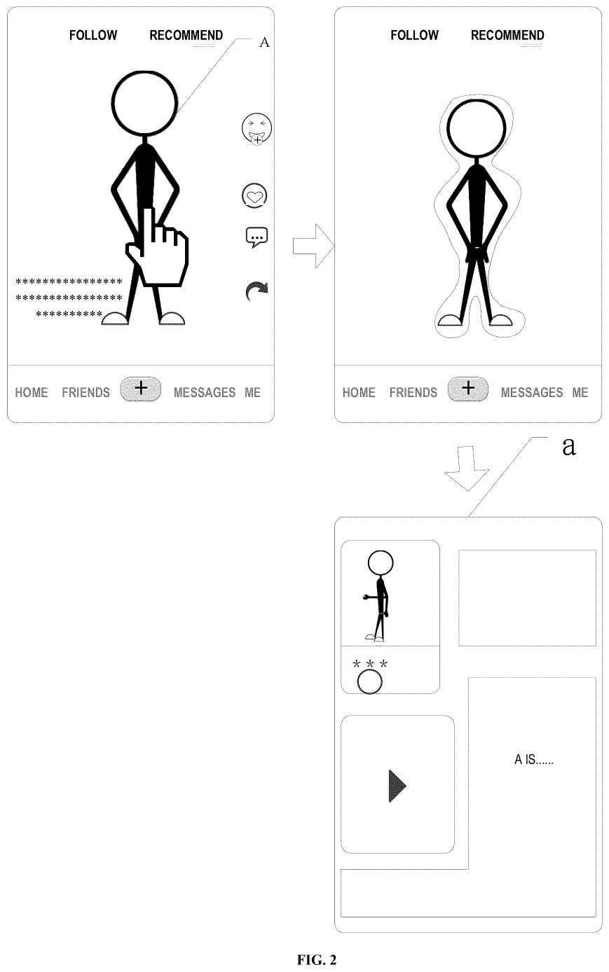

For example, as shown in FIG. 2, when the first object is performer A in the figure, upon detecting a press operation on performer A at the client, the server will obtain a trigger instruction for A. Then, by extracting the object feature information of performer A, multimedia content related to A may be obtained, including short videos about A, associated product information, etc. A page a related to A is generated according to the predetermined template style. Thus, based on page a, the client may have a comprehensive understanding of information about A, shortening the viewing path of A's multimedia content.

During actual execution, when there are multiple first objects (these multiple first objects may be included in the same video frame, or obtained after triggering operations are performed on multiple different video frames in the video stream), a switching menu for the pages corresponding to different first objects may be displayed in the predetermined area of the interface where the page is located. The style of this switching menu may be set according to the needs of the scenario. When a switching operation is detected, the page of another first object will be switched and displayed.

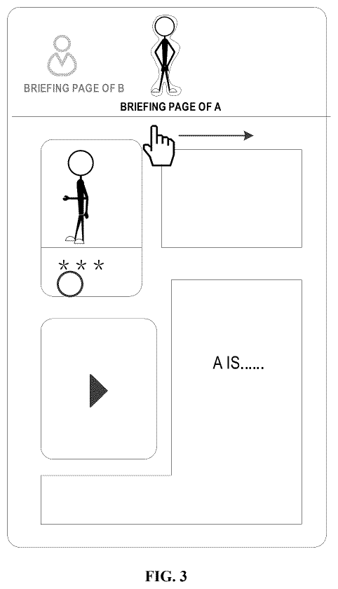

For example, as shown in FIG. 3, when the first objects include A and B, image information of different first objects may also be displayed in the upper area of the interface where the page corresponding to A is located. When a right-slide switching operation is detected, the page of the multimedia content of A currently being displayed may be switched to the page of the multimedia content of B.

In an embodiment of the present disclosure, in response to a second triggering operation, the displaying of the plurality of multimedia content of different multimedia types is terminated, and thumbnail icons corresponding to the plurality of multimedia content of different types are displayed. That is, in this embodiment, to avoid interrupting the video viewing at the client, a close operation may be carried out. In response to a second triggering operation, the displaying of the plurality of multimedia content of different multimedia types is terminated, and thumbnail icons corresponding to the plurality of multimedia content of different types are displayed.

In an embodiment of the present disclosure, to avoid interrupting the video viewing at the client, a predetermined return control may be set. This predetermined return control may be displayed as a floating window or embedded in the page displaying the multimedia content. Thus, in this embodiment, after obtaining a triggering operation for the predetermined return control in the page displaying the multimedia content, it is regarded as obtaining a close display operation for the multimedia content. At least one thumbnail icon corresponding to at least one type of multimedia content is generated, and the client continues to play the corresponding video, that is, returns to the video playback page. At least one thumbnail icon may be displayed in the first predetermined display area on the first video frame. When the corresponding thumbnail icon is triggered, the multimedia content corresponding to the thumbnail icon may be zoomed. The at least one thumbnail icon may be displayed in any style, such as a list style.

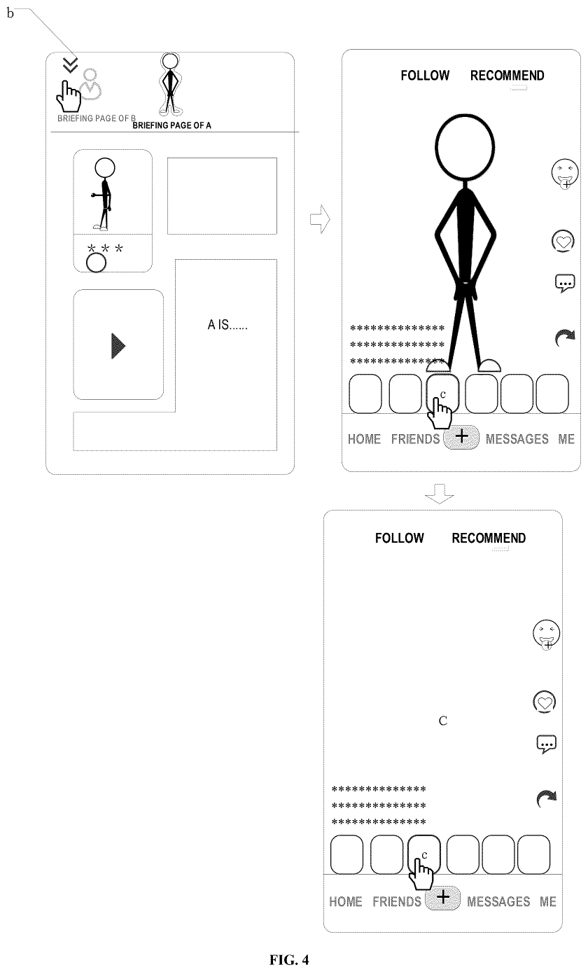

For example, as shown in FIG. 4, when the predetermined return control in the corresponding page is b, if a trigger instruction for b is detected, the video will be returned to continue playing, and at least one thumbnail icon will be displayed at the bottom of the video in a left-right sliding manner. When the user triggers thumbnail icon c, the multimedia content corresponding to c will be zoomed on the current video playback interface. Thus, without affecting video viewing, the viewing efficiency of multimedia content is improved.

When the first video type is a resource promotion type, the associated information includes a resource corresponding to the first video and a resource transfer control.

In an embodiment of the present disclosure, when the video is a resource promotion video, such as a product promotion video, the first resource corresponding to the first video frame and the resource transfer control may be displayed as the associated information. At this time, the first object corresponding to the first video frame is also a product object, also known as the first resource or the first product, and the first video may correspond to multiple product objects.

In this embodiment, the server may identify at least one object element included in the first object using semantic segmentation technology, etc. Each object element may be each separable object unit included in the corresponding first object, and each object element may be pushed as a separate product. For example, when the first object is a set of clothes, the corresponding object elements include the top and bottom clothes in the set of clothes.

To achieve the push of object elements, the first resource corresponding to each object element is determined as the associated information of the first object. The first resource includes, but is not limited to, the push link information of each object element. The push link information may be a link to any information such as a push page, purchase information, etc., which may be set according to the application scenario. Different object elements correspond to different first resources, and each object element may correspond to one or more first resources. The resources are, example, virtual or real items, services, etc.

In some possible embodiments, the first resource corresponding to each object element may be determined in a predetermined push resource library for push objects. The screening method of the first resource may be screened according to parameters such as the purchase volume of each object element in the push resource library.

Furthermore, when controlling the client to display the associated information of the first object, the client is controlled to perform display processing on at least one first resource corresponding to at least one object element on the video interface. For example, a thumbnail image of the corresponding object element of the corresponding first resource is displayed as a push link of the first resource. When performing display processing on at least one first resource of at least one object element, the corresponding display position and display method may be set according to the needs of the scene, with no restrictions here.

In this embodiment, to facilitate the understanding of the first resource, the resource transfer control (such as a purchase control) of the first resource may also be displayed at the client. When the resource transfer control is triggered, detailed information of the corresponding first resource may be displayed, etc. Moreover, the display style of the resource transfer control may be diversified, not being listed one by one here. For example, the resource transfer control may be a push link control for the detailed information of the first resource.

For example, as shown in FIG. 5, when the first object corresponding to the first video frame is a suit of clothes in the figure, the object elements included are a top, a belt, and trousers respectively. Then, the push link information of the top, the belt, and the trousers is obtained as the first resource respectively, and the push link information of each object element is displayed in the form of thumbnails in the lower area of the current video. Among them, different object thumbnails may be switched through a sliding switching operation. In this embodiment, an order placement control corresponding to each first resource may also be provided to facilitate the quick purchase of relevant object elements.

Of course, in order to avoid the situation that the first resource displayed in the form of thumbnails is not clear enough, in some possible examples, a resource transfer control-detail display control corresponding to the first resource may also be displayed at the client. The display style of this detail display control may be set according to the scenario. When a triggering operation for the detail display control is detected at the client, the first resource page of the object element corresponding to the currently viewed thumbnail is displayed at the client. This first resource page contains richer first resources of the corresponding object element, such as detailed pictures of the corresponding element, purchase link information, etc.

When the first resource is displayed in the form of the above thumbnails, in response to a zoom operation for the first resource, the first resource may be zoomed and at least one second video related to the first resource may be presented. The second video may be regarded as a video for detailed explanation of the first resource. For example, if the first resource is the push information of clothing, the corresponding second video may be the push video of the clothing.

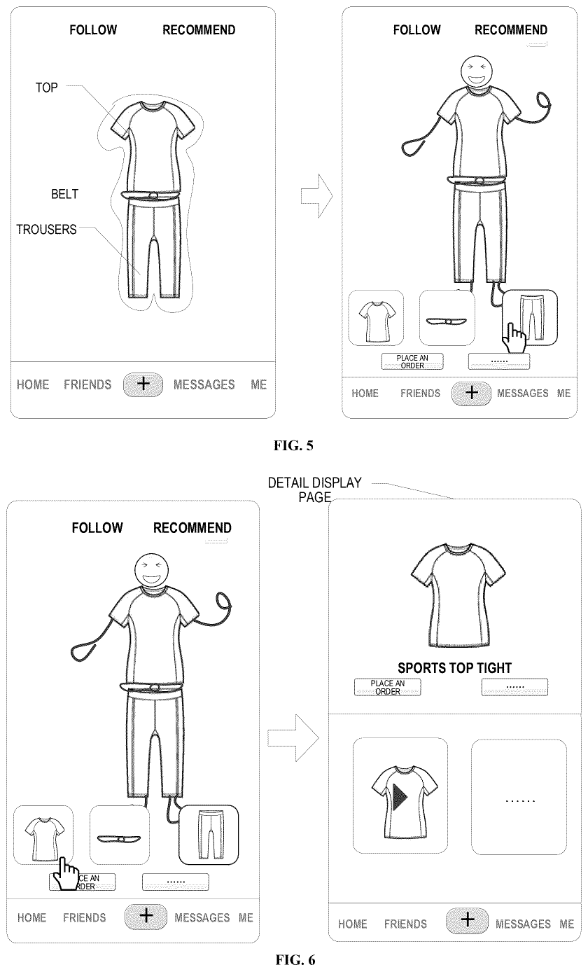

For example, as shown in FIG. 6, when the resource transfer control is integrated on the thumbnail of the first resource, after detecting a triggering operation on the thumbnail of the first resource corresponding to the top, it jumps to the detail display page of the first resource corresponding to the top to display richer first resources corresponding to the top.

In an embodiment of the present disclosure, when performing display processing on the target first resource of at least one first resource, in response to a video progress adjustment operation, the second video frame may also be displayed, and the second resource corresponding to the second video frame may be displayed. The second video frame pushed may be the first video frame that mainly introduces the corresponding object element, or any video frame that mainly introduces the corresponding object element. The object element associated with each video frame may be pre-labeled or obtained by matching degree recognition according to image recognition technology, etc. Then, the client is controlled to jump to the second video frame to play the first video, so as to achieve the correspondence between the object element and the first video and further understand the corresponding object element.

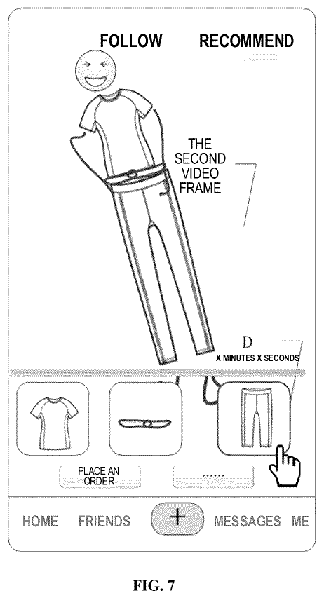

In this embodiment, as shown in FIG. 7, in response to the video progress adjustment operation, the second video frame is displayed, and the second resource corresponding to the second video frame is displayed. For example, when the video jumps to the second video frame of the second resource D, the second resource corresponding to D is displayed to facilitate further understanding of D.

In some possible embodiments, the associated information of the first video is obtained by performing effect processing on the first object associated with the first video. In this embodiment, at least one effect is displayed, and in response to an operation of moving the first object to the target effect of the at least one effect, the second object is displayed.

In response to the first triggering operation, the first object associated with the first video is determined. The determination method of the first object refers to the above embodiments. In response to a selection for the target effect, for example, in response to a triggering operation on the first object, at least one effect is displayed, the selected target effect is determined, and then, based on the first object and the target effect, the second object is generated. The second object may be used as the associated information. When the first video type is an interactive type or an object display type, the associated information may include the second object generated based on the first object and the target effect in the first video.

If there are multiple predetermined effects, the server may identify object information such as the object type of the first object, match the object information with the standard object information corresponding to the predetermined effects, and determine the predetermined effects with a matching degree greater than the predetermined matching degree threshold as candidate effects for processing the first object, so as to ensure the matching degree between the effects and the first object and improve the effect processing effect.

In an embodiment, when the target effect corresponds to the first predetermined effect processing function, an image corresponding to the first object is obtained, effect processing is performed on the image corresponding to the first object according to the target effect processing function, and the second object obtained after the effect processing is used as the associated information of the first object. That is, the associated information corresponding to the first predetermined effect processing function is obtained by performing effect processing on the first object. In an embodiment, the second object may be synthesized according to the image of the first object and the image of the target effect. In this embodiment, the secondary creation needs of the first object may be satisfied.

In an embodiment, in response to a selection for the target effect, the comment corresponding to the second object is further sent, and the comment corresponding to the second object is displayed on the comment panel of the first video. For example, an image of the second object is displayed on the comment panel.

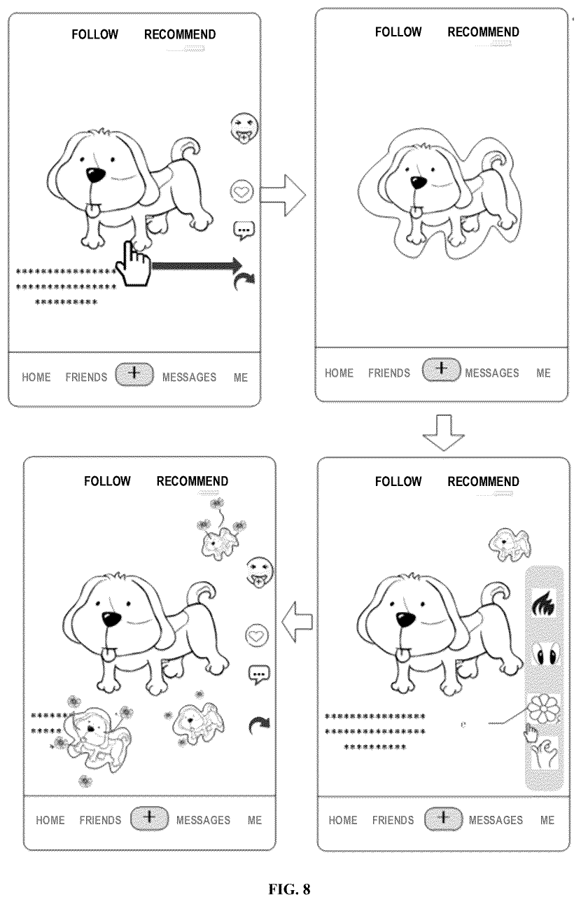

In an embodiment, referring to FIG. 8, after detecting a press and right-drag triggering operation on the “pet dog” in the first video frame at the client during video playback, the client's triggering operation on the “pet dog” is obtained. Thus, at least one effect corresponding to the first object “pet dog” is displayed at the client.

When a selection instruction for the target effect processing control e among at least one effect is obtained, if the target effect processing function corresponding to e is the first predetermined effect processing function, effect processing is performed on the first object “pet dog” to obtain a plurality of interactive images corresponding to the first object “pet dog” as the second object.

In an embodiment, at least one effect may also be fixedly displayed on the video playback page of the first video, and in response to an operation of moving the first object to the target effect of the at least one effect, the second object is displayed.

In an embodiment, the first object may be an object in the first video frame corresponding to the first triggering operation, or it may be an object in other video frames of the first video except the first video frame.

In an embodiment of the present disclosure, a comment instruction from the client may also be received, and image comment information corresponding to the client is generated according to the associated information of the first object. This image comment information may be the image of the first object after the first predetermined effect processing function, or the image of the first object after the second predetermined effect processing function. The comment page of the video is controlled to display the comment information, thus enriching the comment content of the client.

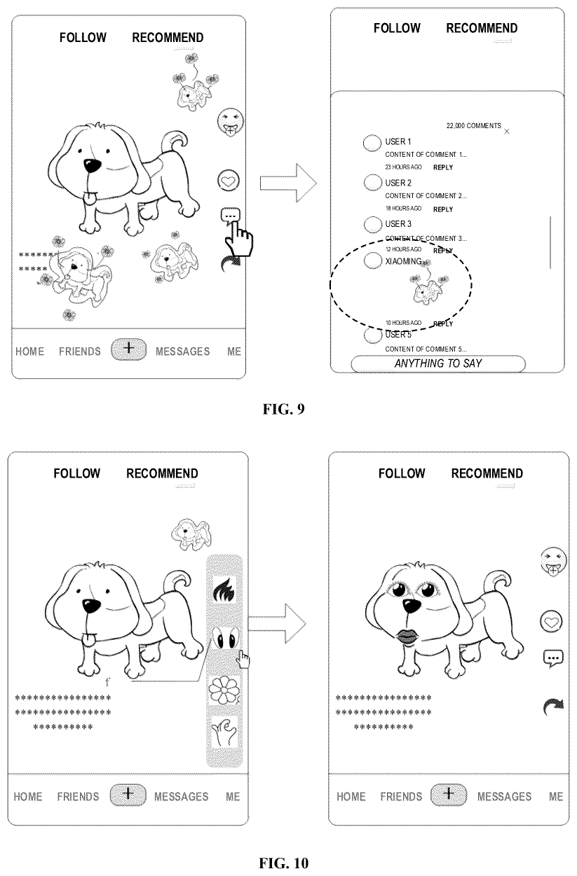

In this embodiment, as shown in FIG. 9, taking the scenario shown in FIG. 8 as an example, when the associated information corresponding to the first effect processing function is obtained, if the triggering operation of the predetermined comment control by the client is detected, the effect processed image corresponding to the “pet dog” will be used as the comment information for the corresponding client. The corresponding client in the figure is “Xiaoming”. Thus, in this embodiment, the richness of the comments is further enhanced.

In this embodiment, the associated first object may also be the triggering object in the current video frame. In this embodiment, the first object in the first video frame of the video is identified, and the client superimposes the effect image information on the first object as the second object.

For example, as shown in FIG. 10, after obtaining the selection instruction for the target effect processing control f of the at least one effect, if the target effect processing function corresponding to f is the second predetermined effect processing function, each frame of the “pet dog” in the video will be identified, and the corresponding texture mapping processing will be carried out following the “pet dog” in the video to increase the fun of video playback. In summary, the video processing method in the embodiments of the present disclosure receives the triggering operation for the first video frame of the first video, and in response to the triggering operation, displays the associated information of the first video. By recommending associated information based on the video, it may flexibly meet the acquisition needs for the associated information of the first video frame in different scenarios, improve the accuracy of acquiring the associated information of the video frame, and shorten the acquisition path of the associated information.

To implement the above embodiments, the present disclosure further proposes an apparatus for video processing.

FIG. 11 is a schematic structural diagram of an apparatus for video processing provided in the embodiments of the present disclosure. This apparatus may be implemented by software and/or hardware and is generally integrated into an electronic device for video processing. As shown in FIG. 11, the apparatus includes a receiving module 1110 and a display processing module 1120. Among them, the receiving module 1110 is configured to receive a first triggering operation for a first video frame of a video; and the display processing module 1120 is configured to in response to the first triggering operation, display associated information of the first video.

The apparatus for video processing provided in the embodiments of the present disclosure may perform the method for video processing provided in any embodiment of the present disclosure, and has the corresponding functional modules and beneficial effects of performing the method, which will not be elaborated here. To implement the above embodiments, the present disclosure further proposes an apparatus for video processing.

To implement the above embodiments, the present disclosure further proposes a computer program product, which includes computer programs/instructions. When the computer programs/instructions are executed by a processor, the method for video processing in the above embodiments is implemented.

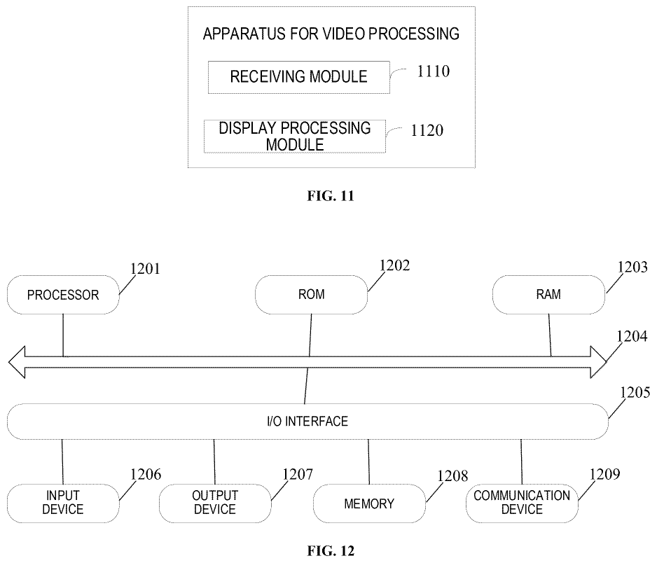

FIG. 12 is a schematic structural diagram of an electronic device provided in the embodiments of the present disclosure.

Specifically referring to FIG. 12 below, it illustrates a schematic structural diagram of an electronic device 1200 suitable for implementing the embodiments of the present disclosure. The electronic device 1200 in the embodiments of the present disclosure may include, but is not limited to, mobile terminals such as mobile phones, laptops, digital broadcast receivers, Personal Digital Assistants (PDAs), Tablet Computers (PADs), Portable Multimedia Players (PMPs), vehicle-mounted terminals (such as vehicle-mounted navigation terminals), and fixed terminals such as digital TVs and desktop computers. The electronic device shown in FIG. 12 is only an example and should not impose any limitations on the functions and application scope of the embodiments of the present disclosure.

As shown in FIG. 12, the electronic device 1200 may include a processor (such as a central processing unit, a graphics processing unit, etc.) 1201, which may execute various appropriate actions and processes according to a program stored in a read-only memory (ROM) 1202 or a program loaded from a memory 1208 into a random access memory (RAM) 1203. In the RAM 1203, various programs and data required for the operation of the electronic device 1200 are also stored. The processor 1201, the ROM 1202, and the RAM 1203 are connected to each other through a bus 1204. An input/output (I/O) interface 1205 is also connected to the bus 1204.

Generally, the following devices may be connected to the I/O interface 1205: input devices 1206 including, for example, touch screens, touchpads, keyboards, mice, cameras, microphones, accelerometers, gyroscopes, etc.; output devices 1207 including, for example, liquid crystal displays (LCDs), speakers, vibrators, etc.; memories 1208 including, for example, magnetic tapes, hard disks, etc.; and communication devices 1209. The communication device 1209 may enable the electronic device 1200 to communicate wirelessly or by wire with other devices to exchange data. Although FIG. 12 shows the electronic device 1200 with various devices, it should be understood that it is not required to implement or have all the shown devices. More or fewer devices may be implemented or possessed instead.

In particular, according to the embodiments of the present disclosure, the processes described above with reference to the flowchart may be implemented as computer software programs. For example, the embodiments of the present disclosure include a computer program product, which includes a computer program carried on a non-transient computer-readable medium, and the computer program contains program codes for executing the method described in the flowchart. In such embodiments, the computer program may be downloaded and installed from the network through the communication device 1209, or installed from the memory 1208, or installed from the ROM 1202. When the computer program is executed by the processor 1201, the above functions defined in the video processing method of the embodiments of the present disclosure are executed.

It should be noted that the above computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, device, or component, or any combination of the above. More specific examples of the computer-readable storage medium may include, but are not limited to: electrical connections with one or more wires, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the above. In the present disclosure, the computer-readable storage medium may be any tangible medium that contains or stores a program that may be used by or in combination with an instruction execution system, device, or component. In the present disclosure, the computer-readable signal medium may include a data signal propagated in the baseband or as part of a carrier wave, carrying computer-readable program codes. Such propagated data signals may take various forms, including but not limited to electromagnetic signals, optical signals, or any suitable combination of the above. The computer-readable signal medium may also be any computer-readable medium other than the computer-readable storage medium, and the computer-readable signal medium may send, propagate, or transmit a program for use by or in combination with an instruction execution system, device, or component. The program codes contained on the computer-readable medium may be transmitted using any appropriate medium, including but not limited to: wires, optical cables, Radio Frequency (RF), etc., or any suitable combination of the above.

In some implementations, clients and servers may communicate using any currently known or future-developed network protocols such as HyperText Transfer Protocol (HTTP), and may be interconnected with digital data communication of any form or medium (for example, a communication network). Examples of communication networks include local area networks (LAN), wide area networks (WAN), the Internet (for example, the Internet), and end-to-end networks (for example, ad hoc end-to-end networks), as well as any currently known or future-developed networks.

The above computer-readable medium may be included in the above electronic device; it may also exist independently without being assembled into the electronic device.

The above computer-readable medium carries one or more programs. When the one or more programs are executed by the electronic device, the electronic device is enabled to: receive a first triggering operation for the first video frame of the first video, in response to the first triggering operation, display the associated information of the first video, recommend associated information based on the video, flexibly meet the acquisition needs for the associated information of the first video frame in different scenarios, improve the accuracy of acquiring the associated information of the video frame, and shorten the acquisition path of the associated information.

The electronic device may write computer program codes for performing the operations of the present disclosure in one or more programming languages or combinations thereof. The programming languages include, but are not limited to, object-oriented programming languages such as Java, Smalltalk, C++, and also conventional procedural programming languages such as the “C” language or similar programming languages. The program codes may be completely executed on the user's computer, partially executed on the user's computer, executed as an independent software package, partially executed on the user's computer and partially on a remote computer, or completely executed on a remote computer or server. In cases involving remote computers, the remote computer may be connected to the user's computer through any kind of network, including a local area network (LAN) or a wide area network (WAN), or may be connected to an external computer (for example, connected to the Internet through an Internet service provider).

The flowcharts and block diagrams in the drawings illustrate the possible implementation architectures, functions, and operations of systems, methods, and computer program products according to various embodiments of the present disclosure. In this regard, each block in the flowchart or block diagram may represent a module, a program segment, or a part of the code, and the part of the module, program segment, or code contains one or more executable instructions for implementing the specified logical functions. It should also be noted that in some alternative implementations, the functions marked in the blocks may also occur in an order different from that marked in the accompanying drawings. For example, two consecutively represented blocks may actually be executed substantially in parallel, and sometimes they may be executed in the opposite order, depending on the functions involved. It should also be noted that each block in the block diagram and/or flowchart, and the combination of blocks in the block diagram and/or flowchart, may be implemented by a dedicated hardware-based system that performs the specified functions or operations, or may be implemented by a combination of dedicated hardware and computer instructions.

The units described in the embodiments of the present disclosure may be implemented by software or hardware. In some cases, the name of the unit does not limit the unit itself.

The functions described above in this article may be at least partially executed by one or more hardware logic components. For example, without limitation, exemplary types of hardware logic components that may be used include: Field Programmable Gate Arrays (FPGA), Application Specific Integrated Circuits (ASIC), Application Specific Standard Products (ASSP), System on a Chip (SOC), Complex Programmable Logic Devices (CPLD), etc.

In the context of the present disclosure, the machine-readable medium may be a tangible medium that may contain or store a program for use by or in combination with an instruction execution system, device, or equipment. The machine-readable medium may be a machine-readable signal medium or a machine-readable storage medium. The machine-readable medium may include, but is not limited to, electronic, magnetic, optical, electromagnetic, infrared, or semiconductor systems, devices, or equipment, or any suitable combination of the above. More specific examples of the machine-readable storage medium will include electrical connections based on one or more wires, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the above.

The above description is only the preferred embodiments of the present disclosure and an explanation of the applied technical principles. Those skilled in the art should understand that the scope of the disclosure involved in the present disclosure is not limited to the technical solutions formed by the specific combination of the above technical features, but also should cover other technical solutions formed by any combination of the above technical features or their equivalent features without departing from the above disclosure concept. For example, technical solutions formed by mutually replacing the above features with technical features having similar functions disclosed in the present disclosure (but not limited to).

In addition, although the operations are described in a specific order, this should not be understood as requiring these operations to be executed in the specific order shown or in sequential order. In certain circumstances, multitasking and parallel processing may be advantageous. Similarly, although several specific implementation details are included in the above discussion, these should not be interpreted as limitations on the scope of the present disclosure. Some features described in the context of separate embodiments may also be implemented in combination in a single embodiment. Conversely, various features described in the context of a single embodiment may also be implemented separately or in any suitable sub-combination in multiple embodiments.

Although the subject matter has been described using language specific to structural features and/or method logical actions, it should be understood that the subject matter defined in the appended claims is not necessarily limited to the specific features or actions described above. Instead, the specific features and actions described above are merely exemplary forms for realizing the claims.

1. A method for video processing, comprising:
receiving a first triggering operation for a first video frame of a first video; and
in response to the first triggering operation, displaying associated information of the first video.

2. The method of claim 1, wherein the associated information is determined according to a video type of the first video.

3. The method of claim 1, wherein displaying the associated information of the first video comprises:
presenting a first resource corresponding to the first video frame and a resource transfer control.

4. The method of claim 1, further comprising:
in response to a video progress adjustment operation, displaying a second video frame and presenting a second resource corresponding to the second video frame.

5. The method of claim 3, further comprising:
in response to a zoom operation for the first resource, zooming the first resource and presenting at least one second video related to the first resource.

6. The method of claim 1, wherein
displaying the associated information of the first video comprises: displaying a plurality of multimedia content of different types related to the first video.

7. The method of claim 6, further comprising:
in response to a second triggering operation, terminating displaying the plurality of multimedia content of different types and displaying thumbnail icons corresponding to the plurality of multimedia content of different types.

8. The method of claim 1, wherein in response to the first triggering operation, displaying the associated information of the first video comprises:
in response to the first triggering operation, determining a first object associated with the first video; and
in response to a selection for a target effect, displaying a second object, the second object being generated based on the first object and the target effect.

9. The method of claim 8, further comprising:
sending a comment corresponding to the second object.

10. The method of claim 7, wherein receiving the first triggering operation for the first video frame of the first video comprises:
receiving a press operation for the first video frame of the first video;
in response to the first triggering operation, obtaining a first object associated with the first video comprises:
in response to the press operation, displaying the first object associated with the first video; and
in response to the selection for the target effect, displaying the second object comprises:
displaying at least one effect, in response to an operation of moving the first object onto the target effect of the at least one effect, displaying the second object.

11. (canceled)

12. An electronic device, comprising:
a processor; and
a memory configured to store executable instructions of the processor;
the processor is configured to read the executable instructions from the memory and execute the executable instructions to implement acts comprising:
receiving a first triggering operation for a first video frame of a first video; and
in response to the first triggering operation, displaying associated information of the first video.

13-14. (canceled)

15. The electronic device of claim 12, wherein the associated information is determined according to a video type of the first video.

16. The electronic device of claim 12, wherein displaying the associated information of the first video comprises:
presenting a first resource corresponding to the first video frame and a resource transfer control.

17. The electronic device of claim 12, wherein the acts further comprise:
in response to a video progress adjustment operation, displaying a second video frame and presenting a second resource corresponding to the second video frame.

18. The electronic device of claim 16, wherein the acts further comprise:
in response to a zoom operation for the first resource, zooming the first resource and presenting at least one second video related to the first resource.

19. The electronic device of claim 12, wherein displaying the associated information of the first video comprises:
displaying a plurality of multimedia content of different types related to the first video.

20. The electronic device of claim 6, wherein the acts further comprise:
in response to a second triggering operation, terminating displaying the plurality of multimedia content of different types and displaying thumbnail icons corresponding to the plurality of multimedia content of different types.

21. The electronic device of claim 12, wherein in response to the first triggering operation, displaying the associated information of the first video comprises:
in response to the first triggering operation, determining a first object associated with the first video; and
in response to a selection for a target effect, displaying a second object, the second object being generated based on the first object and the target effect.

22. The electronic device of claim 21, wherein the acts further comprise:
sending a comment corresponding to the second object.

23. A non-transitory computer-readable storage medium storing a computer program, the computer program configured to execute acts comprising:
receiving a first triggering operation for a first video frame of a first video; and
in response to the first triggering operation, displaying associated information of the first video.
